(19) United States
(12) Patent Application Publication
(10) Pub. No.: US 2012/0003985 A1
(43) Pub. Date: Jan. 5, 2012

(54) CO-CHANNEL INTERFERENCE REDUCTION IN FEMTOCELL NETWORKS

(75) Inventors: Ismail Guvenc, Santa Clara, CA (US); Moo Ryong Jeong, Albany, CA (US); Fujio Watanabe, Union City, CA (US)

(73) Assignee: NTT DOCOMO Inc., Tokyo (JP)

(21) Appl. No.: 13/171,905

(22) Filed: Jun. 29, 2011

Related U.S. Application Data
(60) Provisional application No. 61/360,575, filed on Jul. 1, 2010.

(51) Int. Cl. H04W 72/04

(52) U.S. Cl. 455/452.2

(57) ABSTRACT

Co-channel macrocell users will inherently produce co-channel interference at a nearby femtocell base station. To reduce the peak co-channel interference power, the femtocell users adjust their symbol timing with regard to the macrocell users so as to maximize a spreading of the co-channel interference spectrum. In this fashion, the peak co-channel interference power is reduced, thereby leading to improved bit error rates for the femtocell users.

### RELATED APPLICATION

This application claims the benefit of U.S. Provisional Application No. 61/360,575, filed Jul. 1, 2010.

### TECHNICAL FIELD

The present invention relates to wireless communications technology. More specifically, the present invention relates to the management of co-channel interference observed at a femtocell network that uses multi-carrier signaling.

### BACKGROUND

Femtocell networks are one of the candidate technologies for meeting the demand for increased data rates in next generation wireless communication systems. Each femtocell integrates within a macrocell cellular network. To enable the high data rates required for next generation wireless systems, orthogonal frequency division multiple access (OFDMA) technology has become popular in both the macrocell and the femtocell environment. In that regard, the femtocell can communicate using the same subcarriers as used in the macrocell (a co-channel femtocell) or it can operate using a dedicated set of sub-carriers (a split-channel femtocell). Co-channel operation for a femtocell plainly creates the possibility of interference from macrocell users. The macrocell mobile stations transmit using some of the same sub-carriers as used by femtocell mobile stations and will thus interfere with reception at the femtocell base station of the femtocell mobile station transmissions.

Although co-channel operation inherently has conflict between the macrocell and femtocell users, it is often preferable to split-channel (which may also be denoted as frequency-partitioned) operation because frequency partitioning requires some type of interference-related control message between the macrocell and the femtocell. Such a control message may be problematic in that the existing network protocol may not provide facilities to accommodate the message. For example, in long term evolution (LTE) networks the X2 channel is available for signaling between macrocell base stations but not for signaling between femtocell base stations. Alternatively, the femtocell base stations could sense macrocell interference to avoid reuse of macrocell spectral resources. But such sensing may be challenging to perform. Co-channel operation for OFDMA/OFDM macrocells and femtocells thus remains an attractive option despite its inherent interference issues.

Accordingly, there is a need in the art for co-channel interference (CCI) mitigation techniques for co-channel femtocell networks.

### SUMMARY

Each macrocell mobile station typically occupies just a subset of the available uplink sub-carriers. In contrast, a co-channel femtocell mobile station will typically use all the available uplink sub-carriers. Thus, the co-channel interference (CCI) experienced by a femtocell base station in the uplink will typically be concentrated just in the frequency bands occupied by an interfering macrocell mobile station. By adjusting the symbol synchronization for the femtocell base station with regard to such an interfering co-channel macrocell mobile station, the CCI from the interfering macrocell mobile station is spread outside of the sub-carriers assigned to that mobile station. In this fashion, peak CCI may be minimized at the cost of spreading the bandwidth of the CCI. However, because the peak CCI is dominant in such a co-channel operation, the bit-error rate for the femtocell is improved.

In accordance with an embodiment, a method of mitigating co-channel interference is provided that includes: at a femtocell base station, determining a symbol arrival time for an uplink transmission from an interfering co-channel macrocell mobile station; at the femtocell base station, determining a femtocell uplink symbol timing with regard to the determined symbol arrival time that reduces a peak co-channel interference for the femtocell base station; and communicating the femtocell uplink symbol timing to a femtocell mobile station.

In accordance with another embodiment, a method of mitigating co-channel interference is provided that includes: at a femtocell mobile station, receiving a femtocell uplink symbol timing that reduces a peak co-channel interference for a femtocell base station with regard to an uplink transmission from an interfering co-channel macrocell mobile station; and from the femtocell mobile station, transmitting an uplink symbol to the femtocell base station according to the femtocell uplink symbol timing.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### DESCRIPTION OF FIGURES

FIG. 1 is an illustration of an example femtocell network and a corresponding macrocell network.

FIG. 2a shows a timing relationship for the uplink transmissions from a macrocell mobile station and from a femtocell mobile station.

FIG. 2b shows the spectrums for received signals from a co-channel mobile station before and after CCI abatement as compared to the femtocell spectrum.

FIG. 3 is a graph of bit error rates before and after CCI reduction as a function of the signal-to-interference ratio (SIR).

FIG. 4 is a flowchart for an uplink synchronization method that minimizes CCI.

FIG. 5 is a block diagram of an example femtocell base station and mobile station configured to practice CCI reduction.

Embodiments of the present invention and their advantages are best understood by referring to the detailed description that follows. It should be appreciated that like reference numerals are used to identify like elements illustrated in one or more of the figures.

### DETAILED DESCRIPTION

As discussed above, a co-channel femtocell mobile station will typically utilize all the available sub-carriers in the uplink transmission to its femtocell base station. In contrast, a given macrocell mobile station typically utilizes only a subset of the available sub-carriers in the uplink transmission to its macrocell base station. The co-channel interference experienced by the femtocell base station in the uplink from such a macrocell mobile station is thus concentrated in the frequency bands utilized by the macrocell mobile station. To reduce the impact of the resulting CCI, the femtocell symbol timing is adjusted to spread the CCI outside of the frequency band utilized by the interfering macrocell mobile station. A similar technique may be used to minimize the co-channel interference from an interfering macrocell base station (in the downlink) at the femtocell mobile station so long as the macrocell mobile station is using just a subset of the available sub-carriers. To better understand the advantageous co-channel interference mitigation techniques disclosed herein, the mathematical properties of interference at the femtocell base station in a multi-carrier co-channel macrocell network will first be discussed.

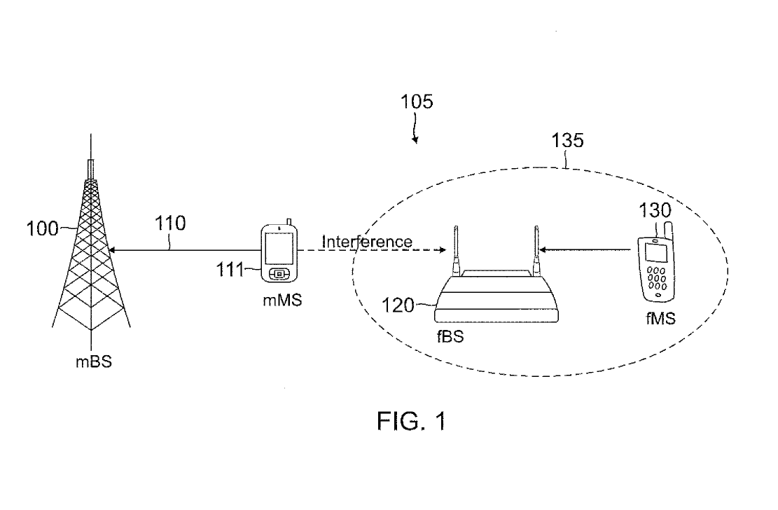

Referring now to the drawings, an example macrocell 105 is shown in FIG. 1. Macrocell 105 includes a base station 100 and a mobile station 111. An uplink transmission 110 from mobile station 111 will interfere with a co-channel uplink transmission from a femtocell mobile station 130 to its femtocell base station 120. In that regard, the uplink OFDM symbols transmitted by femtocell mobile station 130 and interfering (co-channel) mobile station 111 are respectively given by

$$\begin{matrix}{x}_{f}^{j} ( n ) = \sqrt{{P}_{tx , f}} {\sum }_{k = 0}^{N - 1} {S}_{f}^{j} ( k ) {e}^{j2π \frac{k}{N} n} , {N}_{CP} \leq n \leq N - 1 , & ( 1 ) \\ {x}_{m}^{j} ( n ) = \sqrt{{P}_{tx , m}} {\sum }_{k ∈ {𝒦}_{m}} {S}_{m}^{j} ( k ) {e}^{j2π \frac{k}{N} n} , {N}_{CP} \leq n \leq N - 1 , & ( 2 )\end{matrix}$$

where N is number of available subcarriers, j is the OFDM symbol index, P_{tx,f} and P_{tx,m} are the transmit powers of the femtocell and macrocell signals, respectively, k is the subcarrier index, N_{CP} is the length of cyclic prefix, and S^{j}_{f}(k) and S^{j}ₘ(k) are the information symbols carried by the kth subcarrier and jth OFDM symbol of mobile stations 130 and 111, respectively. It is assumed without loss of generality that femtocell mobile station 130 uses all the N available subcarriers in the spectrum (note that a typical number of active femto users per a femtocell is one) and macrocell mobile station 111 uses Nₘ=| [symbol] m| subcarriers specified by a subcarrier allocation map [symbol] m.

The jth symbol from the femtocell and macro mobile stations received at the femtocell base station can thus be respectively written in the time sample domain as

$$\begin{matrix}{y}_{f}^{j} ( n ) = \sqrt{{P}_{rx , f}} {\sum }_{k = 0}^{N - 1} {S}_{f}^{j} ( k ) {e}^{j2π \frac{k}{N} ( n - {D}_{f} )} , {N}_{CP} \leq n \leq N - 1 , & ( 3 ) \\ {y}_{m}^{j} ( n ) = \sqrt{{P}_{rx , m}} {\sum }_{k = {𝒦}_{m}}^{N - 1} {S}_{m}^{j} ( k ) {e}^{j2π \frac{k}{N} ( n - {D}_{m} )} , {N}_{CP} \leq n \leq N - 1 , & ( 4 )\end{matrix}$$

where D_{f} and Dₘ denote the symbol arrival times at the femtocell base station for the femtocell mobile station and the macrocell mobile stations transmissions, respectively. As will be explained further herein, the femtocell base station may adjust the uplink timing misalignment Δ_{D}=Dₘ−D_{f} appropriately in order to spread the CCI bandwidth received from the macrocell. In that regard, it may be assumed without loss of generality that the femtocell base station is perfectly synchronized to its own femtocell mobile station's uplink transmission. A fast Fourier transform over the femtocell's jth symbol duration for the received signal at the femtocell base station will thus have spectral terms Y^{j}(l) where l represents the lₜₕ subcarrier as

$$\begin{matrix}{Y}^{j} ( l ) = FFT \{ {y}_{f}^{j} ( n + {D}_{f} ) + {\tilde{y}}_{m}^{j - 1} ( n + {D}_{f} ) + {\tilde{y}}_{m}^{j} ( n + {D}_{f} ) \} \\ = {P}_{rx , f} {S}_{f}^{j} ( l ) + {P}_{rx , m} {Y}_{m}^{j} ( l ) ,\end{matrix} \qquad ( 5 )$$

where \tilde{y}^{j-1}(•) and \tilde{y}^{j}(•) denote the parts of the (j−1)th and jth macrocell symbol that fall within the jth femtocell symbol, and where

$${Y}_{m}^{j} ( l ) = {S}_{m}^{j} ( l ) \frac{N - {Δ}_{D} + {N}_{CP}}{N} {e}^{- j2π \frac{l}{N} {Δ}_{D}} + {S}_{m}^{j - 1} ( l ) \frac{{Δ}_{D} - {N}_{CP}}{N} {e}^{- j2π \frac{l}{N} ( {N}_{CP} - {Δ}_{D} )} + \frac{1}{N} {\sum }_{k ∈ {𝒦}_{m} , k \neq l} {S}_{m}^{j - 1} ( k ) {e}^{j2π \frac{k}{N} ( {N}_{CP} - {Δ}_{D} )} \frac{1 - {e}^{j2π \frac{( k - l ) ( {Δ}_{D} - {N}_{CP} )}{N}}}{1 - {e}^{j2π \frac{( k - l )}{N}}} - \frac{1}{N} {\sum }_{k ∈ {𝒦}_{m} , k \neq l} {S}_{m}^{j} ( k ) {e}^{- j2π \frac{k}{N} {Δ}_{D}} \frac{1 - {e}^{j2π \frac{( k - l ) ( {Δ}_{D} - {N}_{CP} )}{N}}}{1 - {e}^{j2π \frac{( k - l )}{N}}} . \qquad ( 6 )$$

The first term in equation (6) is the main co-channel interference (CCI) component at the lth subcarrier, the second term corresponds to the inter-symbol interference (ISI) component, and the last two terms correspond to the inter-carrier interference (ICI) components caused by the previous OFDM symbol and the present OFDM symbol, respectively. The interference power corresponding to each of these three components can be written as

$$\begin{matrix}{P}_{M} ( l ) = {P}_{rx , m} \frac{{( N - {Δ}_{D} + {N}_{CP} )}^{2}}{{N}^{2}} , & ( 7 ) \\ {P}_{ISI} ( l ) = {P}_{rx , m} \frac{{( {Δ}_{D} - {N}_{CP} )}^{2}}{{N}^{2}} , & ( 8 ) \\ {P}_{ICI} ( l ) = {P}_{rx , m} \frac{2}{{N}^{2}} {\sum }_{k ∈ {𝒦}_{m} , k \neq l} \frac{1 - cos ( \frac{2 π ( k - l ) ( {Δ}_{D} - {N}_{CP} )}{N} )}{1 - cos ( \frac{2 π ( k - l )}{N} )} , & ( 9 )\end{matrix}$$

and the total interference power on the l-th subcarrier at the femtocell base station can thus be written as

Iₜₒₜ(l)=P_{M}(l)+P_{ISI}(l)+P_{ICI}(l). (10)

Moreover, it follows that the total ICI power on all the subcarriers can be calculated as

$${P}_{ICI \text{-} Tot} = 2 {P}_{rx , m} [ ( \frac{{Δ}_{D} - {N}_{CP}}{N} ) - {( \frac{{Δ}_{D} - {N}_{CP}}{N} )}^{2} ] . \qquad ( 11 )$$

The co-channel interference at the lth sub-carrier is thus given by equations (7) and (8). In contrast, the inter-carrier interference at the lth sub-carrier from the remaining sub-carriers is given by equation (9). A technique to minimize the co-channel interference by spreading the spectral interference outside of the sub-carriers shared by the femtocell and macrocell may be applied in both the downlink and the uplink channels. The following discussion first addresses the minimization of uplink CCI from a dominant interfering co-channel macrocell mobile station. An analogous minimization of the downlink CCI from a co-channel macrocell base station will be addressed subsequently. The symbol synchronization at the femtocell with regard to a dominant interfering mobile station affects how much power is seen for the ICI component as given by equation (9). For example, should the femtocell symbol timing be synchronized to coincide with the symbol reception from the dominant interfering mobile station, the inter-carrier interference is minimized. In other words, if the femtocell timing is such that D_{f}=Dₘ (i.e., if Δ_{D}=0), symbol-level synchronization is achieved with the macrocell, and ICI from the macrocell becomes zero. Conversely, if Δ_{D}>N_{CP}, the power of the macrocell mobile station downlink signal as observed by the femtocell base station leaks from the allocated co-channel subcarriers (defined by [symbol] m) to the neighboring subcarriers in the form of ICI.

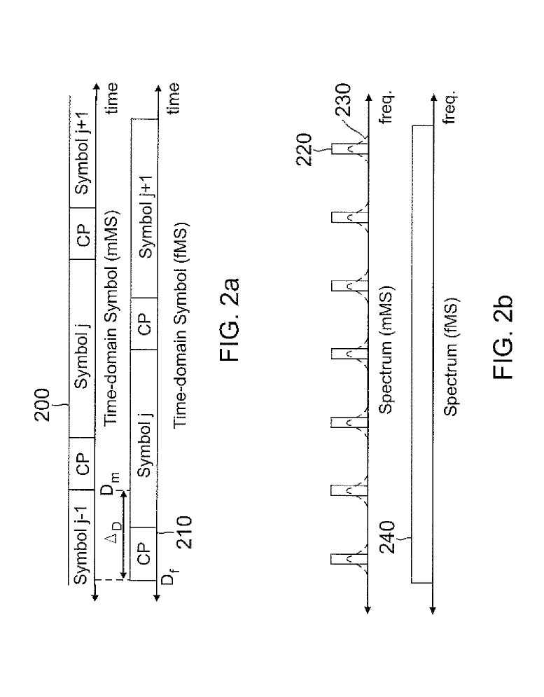

An example ICI-producing timing misalignment is shown in FIG. 2a. A time-domain representation of arriving symbols from the macrocell mobile station at the femtocell base station shows that a jth macrocell symbol 200 is delayed with regard to a jth received femtocell mobile station symbol 210 by delay Δ_{D} that is greater than the symbol prefix length N_{CP}. FIG. 2b shows the resulting spectral spreading of ICI power. Spectrum 220 shows the co-channel interference spectrum at the femtocell base station if the delay Δ_{D} were zero. In this case, the macrocell user transmits in relatively narrow bands 220 that are distributed across a channel 240 occupied by the femtocell mobile station. Conversely, spectrum 230 shows the received co-channel interference spectrum from the macrocell mobile station at the femtocell base station for the delay Δ_{D} shown in FIG. 2a. It may be seen that the peak co-channel interference is reduced at the cost of spreading the co-channel interference across a greater bandwidth. But since the peak power for co-channel interference 220 was far more dominant, the resulting spectral spreading for the received mobile station transmission leads to significant bit-error rate improvements in the femtocell network. It will be appreciated that the ICI spreading so as to reduce the bit error rate will be most effective if macrocell spectrum 220 is restricted to relatively narrow bands that are interleaved across a femtocell channel 240. In contrast, if the macrocell user utilizes more and more of the available sub-carriers, the reduction in the bit error rate may be less. However, so long as the macrocell interferer occupies fewer sub-carriers as compared to those allocated to the femtocell, the techniques disclosed herein advantageously reduce the impact of the CCI by spreading its effects across more sub-carriers.

While frequency spreading of interference is not desirable for a split-spectrum operation, for co-channel operation spreading the total power of the interference outside of the co-channel subcarriers used by the macrocell stations actually reduces the impact of CCI. Using a Gaussian approximation for the interference terms along with (10), and assuming that binary phase shift keying (BPSK) modulation is used, the average bit error rate (BER) observed at a femtocell receiver can be written as

$${P}_{b}^{( GA )} = \frac{1}{N} {\sum }_{l = 1}^{N} Q ( \sqrt{\frac{{E}_{b}}{{I}_{tot} ( l ) + {N}_{0}}} ) , \qquad ( 12 )$$

where E_{b}=P_{rx,f} is the received subcarrier power of the femtocell mobile station signal, and N₀ is the noise power spectral density. While the Δ_{D} that minimizes (12) can be found by getting the derivative of (12), equating it to zero, and solving for Δ_{D}, a heuristic approach is more tractable. In an example heuristic approach, the interference power P_{ICI-Tot} in (11) is maximized to achieve maximum spreading of the CCI. Getting the derivative of (11) with respect to Δ_{D}, we have

$$\frac{d {P}_{ICI \text{-} Tot}}{d {Δ}_{D}} = 2 ( \frac{1}{N} - 2 \frac{{Δ}_{D} - {N}_{CP}}{{N}^{2}} ) = 0 , \qquad ( 13 )$$

which after solving for Δ_{D} yields

$${Δ}_{D} = \frac{N}{2} + {N}_{CP} . \qquad ( 14 )$$

Numerical simulations demonstrate the potential BER improvements at a femtocell with the synchronization approach disclosed herein. While the femtocell mobile station uses a whole available spectrum 240 as shown in FIG. 2b, the macrocell mobile station is assumed to have an interleaved subcarrier allocation as shown by spectrum 220. Both the mobile stations use BPSK modulation, and a single-tap wireless channel is considered for simplicity. The desired signal power and noise level is fixed to obtain a certain receiver E_{b}/N₀ for the desired femtocell mobile station signal, and the interference level is varied to obtain different signal-to-interference ratios (SIRs). Other related system parameters used in the simulations are N=256, N_{CP}=32, and [symbol] m=[0, N/Nₘ−1, . . . , N-Nₘ−1], with Nₘ=32.

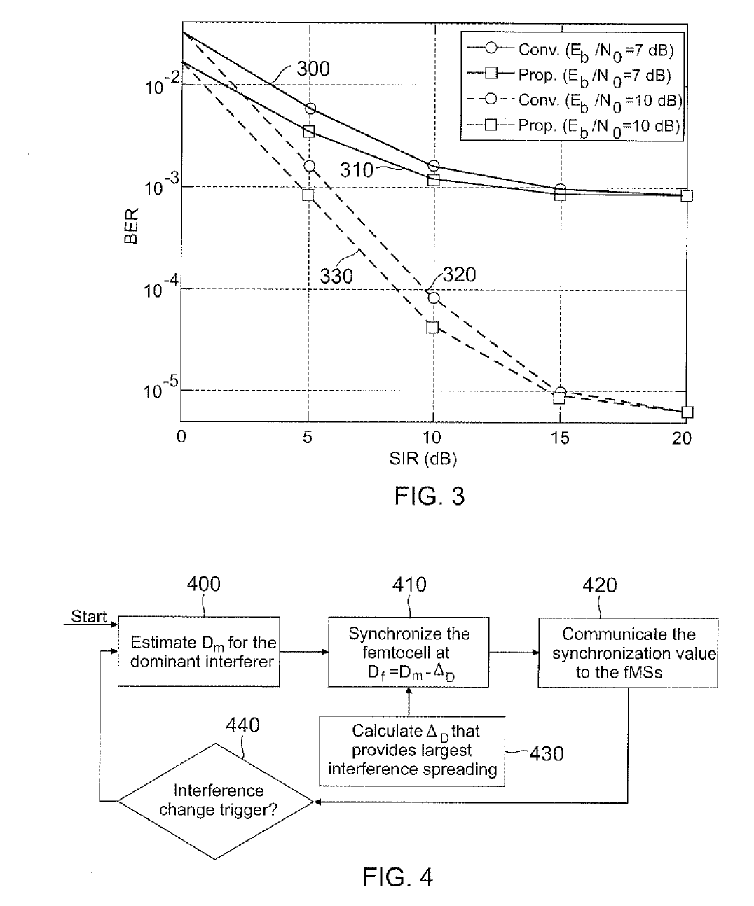

The resulting bit error rates as a function of signal-to-interference ratio (SIR) is shown in FIG. 3. Bit error rates (BERs) 300 and 310 correspond to a conventional symbol-level synchronization (Δ_{D}=0) for an E_{b}/N₀ of 7 dB and 10 dB, respectively. In contrast, BERs 320 and 330 correspond to the optimum synchronization (Δ_{D}=N/2+N_{CP}) of equation (14) also for an E_{b}/N₀ of 7 dB and 10 dB, respectively. Even though the optimum synchronization produces interference on larger number of femtocell subcarriers, because the peak CCI is reduced the BERs are improved dramatically.

A flowchart for a synchronization method to reduce peak CCI is illustrated in FIG. 4. First, the arrival time Dₘ of the dominant macrocell mobile station downlink signal has to be estimated in a step 400. For example, the arrival time for an interfering signal may be estimated using known techniques in the art. In parallel, the parameter Δ_{D} is calculated in a step 430. Various techniques may be used for setting Δ_{D} in order to minimize the BER. As discussed before, one approach is to use the Δ_{D} that provides the maximum spreading of the CCI, where Δ_{D} is calculated such as in equation (14). Note that the use of equation (14) advantageously requires only the knowledge of N and N_{CP}. Knowing Dₘ and Δ_{D}, the synchronization point of the femtocell, D_{f}, can be easily calculated in a step 410. This synchronization point is then communicated to the femtocell users in a step 420, and the same synchronization value is used for subsequent OFDM frames as long as the interference conditions are the same. If there is any change in the interference characteristics as detected in a step 440 (which, e.g., can be determined during the estimation of Dₘ, or, through some other statistical analysis of the received signal, or through some other method), the femtocell can re-adjust its synchronization point by again going through steps 400, 410, 420, and 430.

The synchronization of the femtocell in the downlink is analogous to the uplink synchronization. Downlink interference occurs, for example, if the femtocell is relatively close to a macrocell base station such that the macrocell downlink transmissions from the macrocell base station interfere with the femtocell downlink transmissions being received at the femtocell mobile stations. An analogous procedure to that described for FIG. 4 may thus be followed to address downlink CCI in the femtocell. Step 400 would be replaced by an estimation of the arrival time Dₘ for the interfering macrocell base station. Given this estimation, the synchronization for the downlink symbols may proceed as discussed with regard to steps 410 and 430 for the uplink synchronization. However, whereas uplink has an inherent timing flexibility in that conventional macrocell mobile stations alter their uplink transmission timings with respect to their range from their base station so as to achieve simultaneous reception at the base station, there is no such flexibility that is inherent on the downlink. For example, in the LTE standard, the downlink symbol timing is conventionally static. But to achieve the CCI reduction disclosed herein, the femtocell base station may need to change the downlink symbol boundary in its network in order to reflect the desired Δ_{D}. When the femtocell base station changes the downlink symbol boundary, all the femtocell users need to adjust to this new symbol boundary also. This can be done in a number of ways.

For example, the femtocell base station may apply the symbol boundary adjustment without notifying any active femtocell mobile stations. This may cause link failures and service interruptions to the ongoing communication to the existing users. But the link failure may be recovered and the communication may be reestablished. Alternatively, the timing adjustment may be applied when all the users in the femtocell network are idle. Such an approach may also cause loss of synchronization and the failure of paging message delivery. But these problems will be overcome after the synchronization is recovered. In another alternative, the femtocell base station may apply the adjustment when there are no mobile stations in the femtocell. In this case there is no link failure, loss of synchronization or service interruption. But the femtocell base station may have to wait a relatively long period before it applies the adjustment.

Thus, in another alternative, the femtocell base station may apply the adjustment via a mechanism similar to synchronized reconfiguration. A new command may be created in the RRC (Radio Resource Control) reconfiguration message for this purpose. The command may be denoted as a “resynchronization command.” An example command has two fields: one for indicating how much timing offset to apply and the other for indicating when the timing offset is to apply. In this approach, the adjustment can be applied relatively quickly by delivering the reconfiguration message in a timely manner. Also because the femtocell mobile stations are aware of the adjustment and can resynchronize easily based on the field values in the message, there are no side-effects such as link failure. The reconfiguration message approach is particularly useful when there are relatively few numbers of femtocell users, which is a common scenario.

In yet another alternative, the femtocell base station may apply the adjustment via a mechanism similar to system information change. A new system information message is created for example in the SIB (system information block). The message may be denoted as a “resynchronization message.” An example message has two fields: one for indicating how much timing offset to apply and the other for indicating when the timing offset is to apply. In this approach, the adjustment can be applied relatively quickly by delivering the updated system information in a timely manner. In this fashion, the femtocell users are aware of the adjustment and can resynchronize easily based on the field values in the system information. Thus, there are no side-effects such as link failure. Because the system information is broadcast, this approach may be useful when there are relatively large number of users in the femtocell.

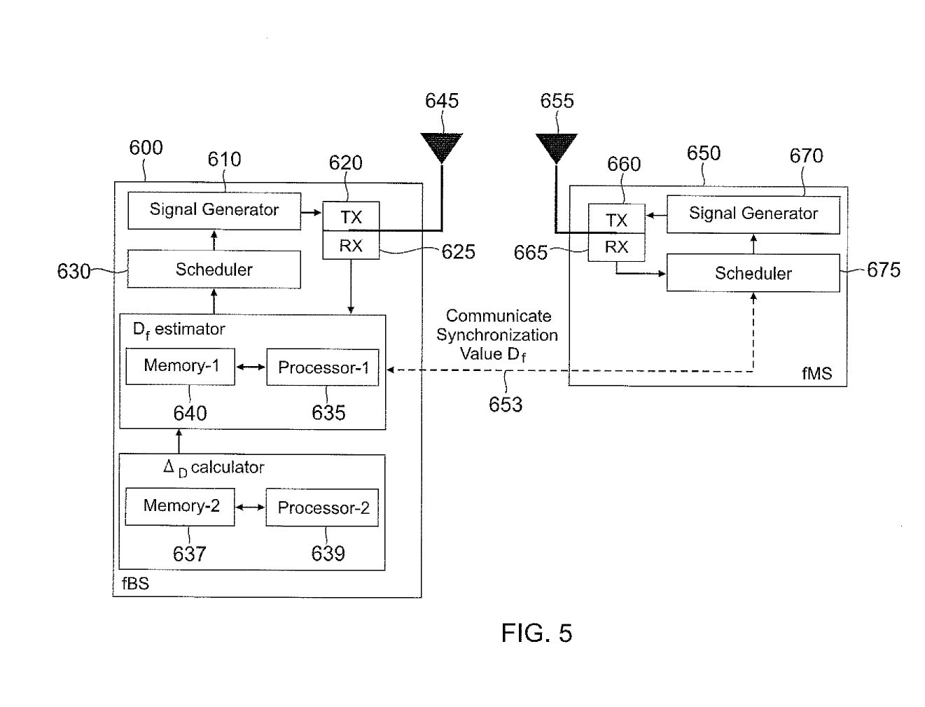

An example transmitter and receiver block diagram for the proposed uplink or downlink synchronization method in a femtocell network is shown in FIG. 5. A femtocell base station 600 includes a transmit/receive module 620. A signal generator 610 may drive module 620 to transmit a desired downlink signal via an antenna 645 to a femtocell mobile station 650. Similarly, module 620 may provide a received uplink signal to a D_{f} estimation module that includes a processor 635 and a memory 640. Processor 635 thus calculates the estimated delay time D_{f} as discussed herein so that the resulting value may be stored in memory 640. Similarly, a Δ_{D} module includes a processor 639 that calculates Δ_{D} based upon the estimated D_{f} and stores the calculated value in a memory 637. It will be appreciated that processors 635 and 639 may comprise a single processor—similarly, memories 640 and 637 may be combined as well. This Δ_{D} value may be communicated to mobile station 650 using the various techniques discussed above (the communication being shown symbolically by a path 653). A mobile station scheduler 675 drives a signal generator 670 that in turn drives a transmit/receive module 660 to transmit an uplink signal via an antenna 655 at the desired synchronization accordingly. Art analogous scheduler 630 in the base station controls the downlink scheduling.

The above-described embodiments of the present invention are representative of many possible embodiments. It will thus be apparent to those skilled in the art that various changes and modifications may be made to what has been disclosed without departing from this invention. The appended claims encompass all such changes and modifications as fall within the true spirit and scope of this invention.

What is claimed is:

1. A method of mitigating co-channel interference, comprising:
at a femtocell base station, determining a symbol arrival time for an uplink transmission from an interfering co-channel macrocell mobile station;
at the femtocell base station, determining a femtocell uplink symbol timing with regard to the determined symbol arrival time that reduces a peak co-channel interference for the femtocell base station; and
communicating the femtocell uplink symbol timing to a femtocell mobile station.

2. The method of claim 1, further comprising:
at the femtocell base station, receiving an uplink symbol from the femtocell mobile station according to the communicated femtocell uplink symbol timing.

3. The method of claim 1, wherein determining the femtocell uplink symbol timing comprises determining a timing offset Δ_{D} that is a function of a number N of sub-carriers for a femtocell uplink channel.

4. The method of claim 3, wherein determining the femtocell uplink symbol timing further comprises determining the timing offset Δ_{D} as a function of a cyclic prefix Cₚ.

5. The method of claim 4, wherein determining the femtocell uplink symbol timing further comprises determining the timing offset Δ_{D} so as to equal a sum of N/2 and Cₚ.

6. A method of mitigating co-channel interference, comprising:
at a femtocell mobile station, receiving a femtocell uplink symbol timing that reduces a peak co-channel interference for a femtocell base station with regard to an uplink transmission from an interfering co-channel macrocell mobile station; and
from the femtocell mobile station, transmitting an uplink symbol to the femtocell base station according to the femtocell uplink symbol timing.

7. The method of claim 6, wherein the femtocell uplink symbol timing occurs according to a timing offset Δ_{D} that is a function of a number N of sub-carriers for a femtocell uplink channel.

8. The method of claim 7, wherein the timing offset Δ_{D} is also a function of a cyclic prefix Cₚ.

9. The method of claim 8, wherein the timing offset Δ_{D} equals a sum of N/2 and Cₚ.

10. A femtocell base station, comprising:
a processor configured to determine a symbol arrival time for an uplink transmission from an interfering co-channel macrocell mobile station, and to determine a femtocell uplink symbol timing with regard to the determined symbol arrival time that reduces a peak co-channel interference for the femtocell base station caused by the interfering co-channel macrocell mobile station; and
a transmitter configured to transmit the femtocell uplink symbol timing to at least one femtocell mobile station.

11. The femtocell base station of claim 10, wherein the processor is configured to determine the femtocell uplink symbol timing according to a timing offset Δ_{D} that is a function of a number N of sub-carriers for a femtocell uplink channel

12. The femtocell base station of claim 11, wherein the timing offset Δ_{D} is also a function of a cyclic prefix Cₚ.

13. The method of claim 12, wherein the timing offset Δ_{D} equals a sum of N/2 and Cₚ.

14. A method of mitigating co-channel interference, comprising:
at a femtocell base station, determining a symbol arrival time for a downlink transmission from an interfering co-channel macrocell base station;
at the femtocell base station, determining a new femtocell downlink symbol timing with regard to the determined symbol arrival time that reduces a peak co-channel interference for the femtocell base station; and
at the femtocell base station, changing a current downlink symbol timing to match the new femtocell downlink symbol timing.

15. The method of claim 14, wherein the femtocell base station changes the current downlink symbol timing during a period in which no femtocell mobile stations are active.

16. The method of claim 14, wherein the femtocell base station changes the current downlink symbol timing during a period in which femtocell mobile stations are active.

17. The method of claim 16, further comprising: prior to the change in downlink symbol timing, communicating the new symbol timing to the active femtocell mobile stations.

18. The method of claim 14, wherein determining the new femtocell downlink symbol timing comprises determining a timing offset Δ_{D} that is a function of a number N of sub-carriers for a femtocell downlink channel.

19. The method of claim 18, wherein the timing offset Δ_{D} is also a function of a cyclic prefix Cₚ.

20. The method of claim 14, wherein the timing offset Δ_{D} equals a sum of N/2 and Cₚ.
